(19) United States
(12) Patent Application Publication
(10) Pub. No.: US 2017/0024375 A1
(43) Pub. Date: Jan. 26, 2017

(54) PERSONAL KNOWLEDGE GRAPH POPULATION FROM DECLARATIVE USER UTTERANCES

(71) Applicant: Microsoft Technology Licensing, LLC, Redmond, WA (US)

(72) Inventors: Dilek Hakkani-Tur, Los Altos, CA (US); Gokhan Tur, Los Altos, CA (US); Xiang Li, New York, NY (US); Qi Li, Sunnyvale, CA (US)

(21) Appl. No.: 14/809,243

(22) Filed: Jul. 26, 2015

(51) Int. Cl. G06F 17/27; G06F 17/30; G10L 25/51

(52) U.S. Cl. CPC G06F 17/2785; G06F 17/2705; G10L 25/51; G06F 17/30958; G06F 17/30684; G06F 17/30707

(57) ABSTRACT

An “Utterance-Based Knowledge Tool” monitors user utterances (e.g., user speech or text inputs) to identify relevant statements of facts in declarative utterances of a user. A semantic parser is applied to each statement of facts to parse assertions comprising instances of two or more entities and relations between those entities. As such, each assertion explicitly delimits a relation between two particular entities (one of which may be the user) that are relevant to the particular user. The Utterance-Based Knowledge Tool places or categorizes the identified assertions (which each include entities and relations) into one or more of a plurality of predefined classes. These classified assertions are then applied to construct and/or update a personal knowledge graph for the user. This personal knowledge graph is then applied to respond to user queries, thereby improving personal relevancy of query responses provided to the user.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be noted or discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

Knowledge graphs provide a powerful representation of entities and the relationships between them. For example, a personal (user-centric) knowledge graph may contain information about the user, including, but not limited to, names of entities such as the user's parents, spouse, children, siblings, etc., additional information about those entities such as their birthdays, schools, etc., user address, employment history, education, languages, various personal preferences, etc.

In general, an “Utterance-Based Knowledge Tool,” as described herein, provides various techniques for automatically populating personal knowledge graphs on a per-user basis. In various implementations, the Utterance-Based Knowledge Tool monitors user speech or text to determine when the user has made a declarative utterance containing positive assertions that define to a relationship between two or more entities. The Utterance-Based Knowledge Tool then parses each assertion to extract the entities and relationships between those entities. These extracted entities and relationships are then applied to construct and/or update a user-centric personal knowledge graph for the user. This personal knowledge graph may then applied to respond to user queries, thereby improving personal relevancy of query responses provided to the user.

For example, in various implementations, the Utterance-Based Knowledge Tool monitors user speech or text inputs to parse and classify one or more assertions in one or more declarative utterances of a particular user. In general, each assertion delimits a relationship (from a plurality of predefined relation classes) between at least two particular entities (one of which may be the user) that are relevant to the particular user. In various implementations, the Utterance-Based Knowledge Tool then constructs or updates a personal knowledge graph relating to the particular user from the classified assertions. Once this personal knowledge base has been constructed, the Utterance-Based Knowledge Tool makes use of one or more elements of the knowledge base to respond to one or more dialog queries of the particular user.

The Utterance-Based Knowledge Tool described herein provides various techniques for automatically populating personal knowledge graphs on a per-user basis based on relations between entities derived from user assertions. In addition to the benefits described above, other advantages of the Utterance-Based Knowledge Tool will become apparent from the detailed description that follows hereinafter.

### BRIEF DESCRIPTION OF THE DRAWINGS

The specific features, aspects, and advantages of the claimed subject matter will become better understood with regard to the following description, appended claims, and accompanying drawings where:

FIG. 1 illustrates a general flow diagram for automatically populating personal knowledge graphs from declarative user utterances on a per-user basis using an “Utterance-Based Knowledge Tool,” as described herein.

FIG. 2 provides an exemplary architectural flow diagram that illustrates program modules for effecting various implementations of the Utterance-Based Knowledge Tool, as described herein.

FIG. 3 provides a general system flow diagram that illustrates an exemplary implementation of the Utterance-Based Knowledge Tool, as described herein.

FIG. 4 provides a general system flow diagram that illustrates an exemplary implementation of the Utterance-Based Knowledge Tool, as described herein.

FIG. 5 provides a general system flow diagram that illustrates an exemplary implementation of the Utterance-Based Knowledge Tool, as described herein.

FIG. 6 is a general system diagram depicting a simplified general-purpose computing device having simplified computing and I/O capabilities for use in effecting various implementations of the Utterance-Based Knowledge Tool, as described herein.

### DETAILED DESCRIPTION

In the following description of various implementations of an “Utterance-Based Knowledge Tool,” reference is made to the accompanying drawings, which form a part hereof, and in which is shown by way of illustration specific implementations in which the Utterance-Based Knowledge Tool may be practiced. It should be understood that other implementations may be utilized and structural changes may be made without departing from the scope thereof.

Specific terminology will be resorted to in describing the various implementations described herein, and it is not intended for these implementations to be limited to the specific terms so chosen. Furthermore, each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Utterance-Based Knowledge Tool. Further, the appearance of such phrases throughout the specification are not necessarily all referring to the same implementation, and separate or alternative implementations are not mutually exclusive of other implementations. The order described or illustrated herein for any process flows representing one or more implementations of the Utterance-Based Knowledge Tool does not inherently indicate any requirement for the processes to be implemented in the order described or illustrated, and any such order described or illustrated herein for any process flows do not imply any limitations of the Utterance-Based Knowledge Tool.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

1.0 Introduction:

In general, an “Utterance-Based Knowledge Tool,” as described herein, provides various techniques for automatically populating personal knowledge graphs on a per-user basis based on “relations” between “entities” derived from user “assertions” in user utterances. In various implementations, the Utterance-Based Knowledge Tool monitors user utterances (e.g., user speech or text inputs) to identify one or more assertions in declarative utterances of a particular user. The Utterance-Based Knowledge Tool applies a semantic parser to each assertion to extract instances of two or more entities and the relation between those entities. The classified assertions are then applied to construct and/or update a personal knowledge graph for the user. This personal knowledge graph is then applied to respond to user queries, thereby enhancing user experience and improving personal relevancy of query responses provided to the user.

Each assertion explicitly delimits a relation (from a plurality of predefined relation classes) between at least two particular entities that are relevant to the particular user. Generally, one of the entities is often the user or some other person relevant to the user. However, entities are not necessarily persons. For example, entities also include, but are not limited to, a wide variety of characteristics, preferences, or other attributes relating to persons, pets, artifacts, etc., that are relevant to the user.

More specifically, in various implementations, the Utterance-Based Knowledge Tool provides an automated spoken language understanding (SLU) framework that constructs user-centric personal knowledge graphs from conversational spoken utterances, sentences, or snippets of user speech. In various implementations, this approach includes, but is not limited to, language understanding components, including 1) personal assertion classification, 2) relation detection, and 3) entity slot filling. These concepts are described in further detail below.

In various implementations, assertions are based on an assertion framework with slots for relation and entities, such as, for example, assertion={relation: x (entity 1: y, entity 2: z)}. In this exemplary framework, entity z is related to entity y by relation x. For example, the user utterance “ . . . I am vegetarian . . . ” can be modeled using the aforementioned assertion framework as {relation: dietary_preference (entity 1: user, entity 2: vegetarian)} or simply {dietary_preference (user, vegetarian)}. Each assertion may then be used to create or update an entry in the user-centric personal knowledge graph.

Further, in various implementations, the personal knowledge graph constructed by the Utterance-Based Knowledge Tool includes two or more links between related entities. For example, in various implementations, the Utterance-Based Knowledge Tool applies an inference framework to solve and link sophisticated relations invoked in various user utterances. For example, the utterance “ . . . my wife Susan was born in Turkey . . . ”, directly links a “place of birth” type relation with a “location” type entity (i.e., “Turkey”) and a “person” type entity (i.e., “Susan”), while also linking the entity of “Susan” to the entity of “user” via a “wife” or “spouse” relation. In various implementations, these entities and relations can be formatted as {birthplace (Susan, Turkey)} and {spouse (user, Susan)}.

Further, by allowing linkages between the same entity for different assertions (whether or not those assertions originated from the same utterance), complex queries can be answered from the resulting personal knowledge graph. In some cases, these types of links can be considered as a type of sub-knowledge graph centered on a particular entity so that multiple linked attributes and related entities can be considered when applying the personal knowledge graph to respond to user queries. For example, given the following assertions with links between the entity “Susan”:
{birthplace (Susan, Turkey)}
{spouse (user, Susan)}
   a complex user query such as “ . . . where was my wife born?” can be answered from these assertions by a response such as “ . . . Susan was born in Turkey . . . ”

Similarly, linkages between relations may also be included in the personal knowledge graph. For example, assume that the user has two children (e.g., “Alex” and “Eileen”). The corresponding assertions in the personal knowledge graph may be {children (user, Alex)} and {children (user, Eileen)}. By linking the “children” relation, complex queries such as “ . . . does Alex have any brothers or sisters?” can be answered from these assertions by a response such as “ . . . Alex has a sister named Eileen . . . ” More specifically, the linkage between the “children” relation is sufficient to infer that since Alex and Eileen have a children relation to the user (meaning both are the user's children), then Eileen (searchable as a girl's name via external sources) is Alex's sister. As such, these types of linkages between multiple entities, multiple relations, or combinations of multiple entities and relations, enable a wide range of complex queries to be answered from information derived from multiple related assertions in the personal knowledge graph.

In various implementations, further searches may be performed against one or more external databases or using one or more internet search engines to obtain additional information relating to one or more of the assertions (or the specific relations or entities of the assertion) in the personal knowledge graph. For example, assume that the user issues a verbal or textual query “are there any good restaurants near here?” The Utterance-Based Knowledge Tool can consider the personal knowledge graph of the user to find that the user has a dietary preference for vegetarian food (e.g., {dietary_preference (user, vegetarian)}. The Utterance-Based Knowledge Tool can then perform an internet or other search for vegetarian restaurants near a current location of the user (e.g., Los Altos, Calif.) and then respond (either directly or via a virtual personal assistant (VPA) or other UI) to the user query with one or more of the corresponding search results, e.g., “I've heard that Chef Chu's restaurant in Los Altos serves good vegetarian Chinese food.”

1.1 System Overview:

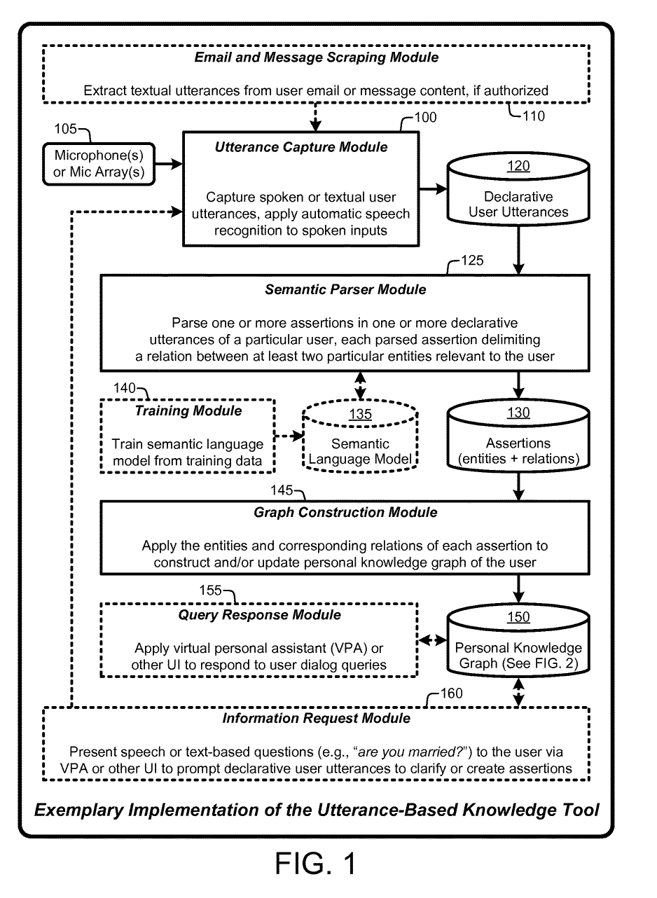

As noted above, the “Utterance-Based Knowledge Tool,” provides various techniques for automatically populating personal knowledge graphs on a per-user basis based on relations between entities derived from user assertions in spoken or textual declarative user utterances. The processes summarized above are illustrated by the general system diagram of FIG. 1. In particular, the system diagram of FIG. 1 illustrates the interrelationships between program modules for implementing various implementations of the Utterance-Based Knowledge Tool, as described herein. Furthermore, while the system diagram of FIG. 1 illustrates a high-level view of various implementations of the Utterance-Based Knowledge Tool, FIG. 1 is not intended to provide an exhaustive or complete illustration of every possible implementation of the Utterance-Based Knowledge Tool as described throughout this document.

In addition, any boxes and interconnections between boxes that may be represented by broken or dashed lines in FIG. 1 represent optional or alternate implementations of the Utterance-Based Knowledge Tool described herein, and any or all of these alternate or optional implementations, as described below, may be used in combination with other implementations that are described throughout this document.

In general, as illustrated by FIG. 1, the processes enabled by various implementations of the Utterance-Based Knowledge Tool begin operation by applying an Utterance Capture Module 100 to capture spoken user utterances by using a microphone or microphone array 105 (or other audio input source or audio capture device) to capture user speech (live or previously recorded). In various implementations, the Utterance Capture Module 100 applies automatic speech recognition (ASR) to the captured speech inputs to generate corresponding text versions of declarative user utterances 120 for further processing. Alternately or in combination, in various implementations, the Utterance Capture Module 100 directly receives text versions of declarative user utterances 120 from an Email and Message Scraping Module 110 that automatically extracts one or more textual utterances from user email and/or messaging content, if authorized.

Next, a Semantic Parser Module 125 automatically parses one or more assertions 130 in one or more of the declarative user utterances 120 of a particular user. As discussed in further detail herein, each parsed assertion delimits a relation (from a plurality of predefined relation classes) between at least two particular entities that are relevant to the user. For example, the user utterance “ . . . I am 42 years old . . . ” includes statements of a relation (i.e., age) between two entities (i.e., “user” and “number of years old”), e.g., {relation: age (entity 1: user, entity 2: 42)}, or more simply, {age (user, 42)}. Similarly, the user utterance “ . . . my wife Jane is vegetarian . . . ” is a statement that includes at least two different assertions of relations between two different entities, e.g., {spouse (user, Jane)} and {dietary_preference (Jane, vegetarian)}.

In various implementations, the Semantic Parser Module 125 applies a semantic language model 135 to parse the assertions 130 in the declarative user utterances 120. In various implementations, the semantic language model 135 is automatically learned via a Training Module 140 that applies various learning techniques to construct the semantic language model from large sets of training data. In general, training of the semantic language model 135 via the Training Module 140 can be accomplished using any desired modeling technique. Examples of such modeling techniques include, but are not limited to, various supervised modeling techniques, unsupervised modeling techniques, and combinations of supervised and unsupervised modeling techniques, any of which may or may not make use of various machine-learning techniques. As such, regardless of how the semantic language model 135 is created, learned or trained, that semantic language module is applied by the Semantic Parser Module 125 to parse one or more assertions in one or more declarative utterances 120 of a particular user.

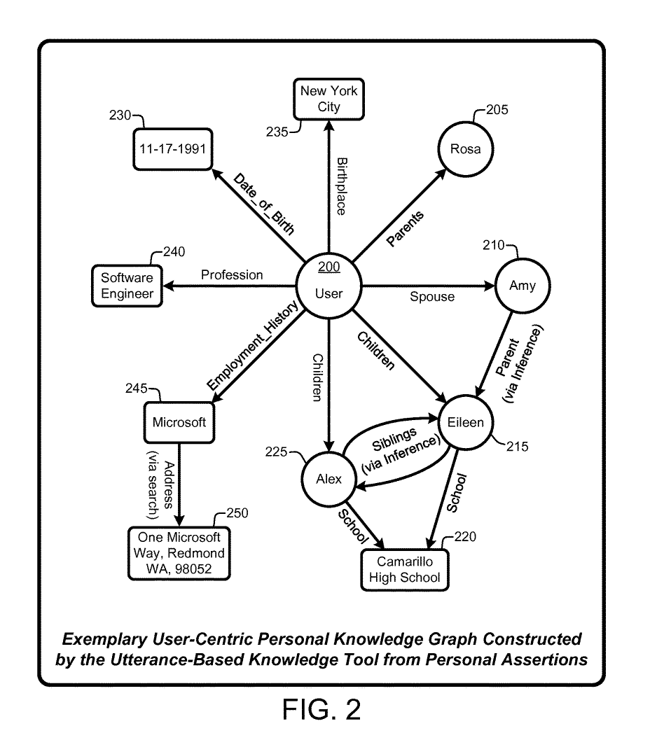

A Graph Construction Module 145 then applies the entities and corresponding relations of each assertion to construct and/or update a user-centric personal knowledge graph 150 for each particular user. FIG. 2, discussed below, provides a graphical illustration of an exemplary implementation of a personal knowledge graph. In various implementations, a Query Response Module 155 then applies information extracted from the personal knowledge graph 150 to respond to spoken or text-based dialog queries of the particular user (or queries of others that may be authorized to access the personal knowledge graph of the user).

In various implementations, an optional Information Request Module 160 presents relevant speech or text-based questions (e.g., “ . . . are you married?”) to the user via a VPA or other UI as a chitchat type prompt in order to obtain declarative utterances from the user. For example, users have frequently been observed to interact with their VPAs to ask them personal questions, such as, for example, whether the VPA is married (e.g., “ . . . hey Cortana, are you married?”). The Information Request Module 160 can then respond directly (or direct the VPA or other UI to respond) with related leading questions or prompts, such as “no, I'm not married, what about you?”. If the user then responds with any declarative utterance (e.g., “yes”, “no” or “I have a wife named Susan”) that utterance can be used to populate entity and relation slots in a corresponding assertion (classified based on the prompt and utterance) by extracting the entities and relation from that utterance (e.g., {spouse, (user, Susan)}.

In various implementations, the Utterance-Based Knowledge Tool may direct the VPA or other UI to ask the user questions based on observations of the user's location over time. For example, if the user if observed by the Utterance-Based Knowledge Tool to frequent a particular Indian restaurant, the Utterance-Based Knowledge Tool or a VPA or other UI may prompt or query the user with a question such as, for example, “You've gone to this restaurant several times, do you like Indian food?” In other words, in various implementations, the Utterance-Based Knowledge Tool automatically prompts the user for particular assertions based on automated location determinations.

As another example, in response to a user query “ . . . I need directions to my daughter's school . . . ”), if relevant assertions have not already been added to the personal knowledge graph, the Information Request Module 160 can respond to the user via the VPA or other UI with a question or prompt such as, for example, “I didn't know you have a daughter, where does she go to school?” If the user then responds with a declarative utterance such as, for example, “ . . . Jennifer is a sophomore at Camarillo High School . . . ” that utterance can be used to populate slots of corresponding assertions for populating the personal knowledge graph. Further, in various limitations, the Utterance-Based Knowledge Tool can populate slots of the corresponding assertions in real-time by applying the techniques described above as soon as the Utterance Capture Module 100 receives that utterance.

For example, the aforementioned declarative utterance results in multiple assertions, including {children (user, Jennifer)}, {school (Jennifer, Camarillo High School)}, and {grade_level (Jennifer, sophomore)}. Then, given the real-time addition of the assertion {school (Jennifer, Camarillo High School)} to the user's personal knowledge graph, a VPA or other UI can immediately respond to the user's original query by providing the requested directions after performing a real-time external map search for directions to “Camarillo High School” from the user's current location. Each of those new assertions will also then be available in the personal knowledge graph for use in responding to any subsequent user queries that may be relevant to those assertions.

2.0 Operational Details of the Utterance-Based Knowledge Tool:

The above-described program modules are employed for implementing various implementations of the Utterance-Based Knowledge Tool. As summarized above, the Utterance-Based Knowledge Tool provides various techniques for automatically populating personal knowledge graphs on a per-user basis based on relations between entities derived from user assertions in declarative user utterances. The following sections provide a detailed discussion of the operation of various implementations of the Utterance-Based Knowledge Tool, and of exemplary methods for implementing the program modules described in Section 1 with respect to FIG. 1. In particular, the following sections provides examples and operational details of various implementations of the Utterance-Based Knowledge Tool, including:
Operational Overview of the Utterance-Based Knowledge Tool;
Personal Assertions;
Training Data Collection and Semantic Model Training;
Personal Assertion Detection and Classification;
Personal Knowledge Graph Construction and Updates;
Inferring Information for Personal Knowledge Graphs;
Sharing Personal Knowledge Graphs with Other Users; and
Exemplary Usage Scenarios.

2.1 Operational Overview:

As noted above, the Utterance-Based Knowledge Tool-based processes described herein provide various techniques for automatically populating personal knowledge graphs on a per-user basis based on relations between entities derived from user assertions. A simple example of a declarative utterance with assertions may be “ . . . my daughter attends Camarillo High School . . . ” This simple declarative utterance contains two separate assertions. First, the user has a daughter (whose name may be known from other declarations or other information sources), and second, the user's daughter attends Camarillo High School.

In various implementations, these assertions are classified from declarative user utterances by aligning a SLU semantic space of the Utterance-Based Knowledge Tool with a custom or pre-existing structured knowledge repository (e.g., freebase.com, schema.org, etc.) based on entity and relation triples (e.g., assertion={relation: x (entity 1: y, entity 2: z)}. In other words, in various implementations, the Utterance-Based Knowledge Tool parses assertions in declarative user utterances by applying a semantic space that corresponds to multiple predefined classes of assertions that include slots for both relations and entities.

In general, these types of existing structured knowledge repositories provide a predefined structure for multiple categories of data. As such, use of these types of predefined structures by the Utterance-Based Knowledge Tool is useful to ensure that the resulting personal knowledge graph is compatible with a wide range of existing applications, VPAs and other UIs. However, the Utterance-Based Knowledge Tool can use any desired format, structure, or ontology, for the assertions added to the personal knowledge graph by simply modeling or training the semantic parsing features of the Utterance-Based Knowledge Tool to match whatever classes or categories of assertions are being considered for construction of the personal knowledge graph.

2.2 Personal Assertions:

Typically, VPA systems or other interactive UIs apply advanced SLU capabilities, which are robust to variability in natural language, ASR noise, and spontaneous ungrammatical spoken input to determine user intent with respect to the user's spoken (or textual) input. For example, in typical VPA systems, at each turn, a user's speech input, Sᵢ, is recognized, and then the SLU component semantically parses that speech input into a task-specific semantic representation of the user's intention, Uᵢ, (e.g., “play music”, “check weather”, etc.) in combination with one or more associated arguments (e.g., name of the artist or location).

A dialog manager component of the SLU system of the VPA or other UI then interprets Uᵢ and decides on the most appropriate system action, Aᵢ, exploiting semantic context, and user specific meta-information, such as geo-location and personal preferences, and other contextual information. For example, if the user clicks on a map on the screen and says “How much is the cheapest gas around here?”, the VPA system or other UI attempts to interpret the domain, intent, and the associated arguments, such as, for example, Domain: Local Business; Intent: Get Price; Slots: good: gas; cost_relative: cheapest; location: (latitude, longitude).

Typically, queries to a dialog system may be classified into various query categories, including, but not limited to, informational queries, transactional queries, and navigational queries in a similar way to the taxonomy for web search. Informational queries are generally directed towards obtaining an answer to a question, e.g., “ . . . find the movies of a certain genre and director . . . ” Transactional queries are generally directed towards performing an operation, e.g., “ . . . play a movie . . . ” or “ . . . reserve a table at a restaurant . . . ” Navigational queries are generally directed towards navigating in the dialog, e.g., “ . . . go back to previous results . . . ”

However, in contrast to applying SLU-based processes to determine user query intent or query categories, the Utterance-Based Knowledge Tool specifically considers personal assertion type utterances that are often conveyed by users talking about themselves, e.g., “ . . . I am vegetarian . . . ” or “ . . . my daughter is getting married . . . ” whether or not there is any particular query intent.

More formally, a personal assertion is defined herein as a declarative sentence, utterance or snippet (in contrast to imperative, interrogative, or other types of utterances or queries). As such, personal assertion utterances are directed towards describing personal facts where the subject of the sentence is either the user (e.g., “I”) or somebody/something related to the user (e.g., “my wife”, “my birthday”, “our dog”, “my car”, “my daughters school”, etc.). Clearly, such personal information may vary greatly. As such, in various implementations, the Utterance-Based Knowledge Tool applies various SLU-based techniques to classify and extract the entities and relations defining each assertion by exploiting semantic knowledge graphs of the semantic web and semantic search.

As described throughout this document, the Utterance-Based Knowledge Tool applies various SLU-based techniques to interpret user utterances to parse assertions in those utterances. Moreover, once the Utterance-Based Knowledge Tool constructs a user-centric personal knowledge graph for each user, in various implementations, the Utterance-Based Knowledge Tool populates a global knowledge network (if authorized by the user) by aggregating and integrating one or more personal knowledge graphs through entity linking for related or otherwise authorized users (e.g., family members, friends, employer, etc., that are expressly authorized by the user to access some or all of the user's personal knowledge graph).

Advantageously, this type of paradigm for applying SLU to declarative user utterances to parse assertions for use in constructing personal knowledge graphs improves user interaction experiences with VPAs and other UIs by ensuring that query responses drawn from the personal knowledge graph are relevant to the user's relationships and behaviors and preferences. Further, in addition to applying the personal knowledge graph to customize query responses provided to the user, the personal knowledge graph constructed by the Utterance-Based Knowledge Tool also enhances the performance of a variety of SLU systems from many aspects.

For example, typical SLU-based systems (e.g., VPAs, UIs, etc.) may not appropriately respond to a query such as “ . . . show directions to my daughter's school . . . ” However, by providing SLU-based systems access to the user-centric personal knowledge graph constructed the Utterance-Based Knowledge Tool, the SLU-based system can perform a simple lookup or scanning operation on the personal knowledge graph to obtain highly relevant information. For instance, continuing the preceding example, the personal knowledge graph constructed by the Utterance-Based Knowledge Tool may associate “ . . . my daughter's school . . . ” with the street address of the user's daughter's school. As such, the SLU-based system can apply the personal knowledge graph to respond to the user's school directions query with either the address of the school, or, in combination with GPS or other localization services, turn-by-turn directions to the school.

Not all assertions are relevant. For example, the user may assert “ . . . giraffes eat leaves . . . ” These types of assertions are not relevant to the user, and as such, they are not included in the user's personal knowledge graph.

2.3 Training Data Collection and Semantic Model Training:

In various implementations, the Utterance-Based Knowledge Tool utilizes a semantic space that is defined by any desired custom or pre-existing knowledge base constructed from entity and relation based triples (or more complex relationships). Simple examples of entity-based triples include the “/people/person/” ontology of freebase.com for relating people or facts to entities. In general, a triple in this sense typically consists of two entities linked by some relation, similar to the well-known predicate/argument structure. A simple example of this type of triple is {birthplace (Bill Gates, Seattle)}.

In various implementations, the Utterance-Based Knowledge Tool builds an SLU model tailored to these types of semantic ontologies for use in parsing assertions from declarative user utterances. For example, in various implementations, the Utterance-Based Knowledge Tool creates a training data set by mining training examples returned by a search (internet or other data store) for entity pairs that are related to each other in a generic knowledge graph corresponding to the particular semantic ontology being used (e.g., a generic knowledge graph based on the “/people/person/” ontology of freebase.com). In other words, in various implementations, for each relation-entity triple (i.e., entity pairs and linking relation) in the semantic ontology, the Utterance-Based Knowledge Tool leverages the complete set of entities that are connected to each other in that ontology with the specific relation to search these entity pairs and linking relation on the internet or other data store. In addition, in various implementations, the Utterance-Based Knowledge Tool also uses language or utterance snippets returned that the search engine to create natural language examples that can be used as the training data for each relation.

For example, in various implementations, the Utterance-Based Knowledge Tool extracts a set of entity pairs in a given domain that are connected with a specific relation from the knowledge base (e.g., http://www.bing.com). In various implementations, the Utterance-Based Knowledge Tool applies various semantic models to directly detect relations and entities invoked in declarative user utterances. Furthermore, in various implementations the training data is enhanced with web search queries directed to similar information as dialog system users.

More specifically, assume AS is the set of all snippets returned for the pair of entities a and b via a web search that downloads the top j search results for each entity pair. The Utterance-Based Knowledge Tool then chooses a subset SAS of AS that includes snippets with both of the entities that were the subject of the search, e.g., SAS={s: εAS [symbol] includes (s, a) includes (s, b)} where includes (x, y) is a binary function that has a value of 1 if string x contains y as a substring. One approach applied by the Utterance-Based Knowledge Tool is to use the complete strings of the snippets for each relation as training examples. However, the snippets can contain more than one correct relation tuple. Consequently, in order to capture more relations in the mined snippet sentences, in various implementations, the Utterance-Based Knowledge Tool applies an additional procedure to post-process these snippets to augment the relation tags from the semantic ontology (e.g., freebase.com or other ontology), since many crawled instances actually contain more than one relation.

For example, existing knowledge bases or internet searches may be mined to obtain data relating to each relation of the semantic ontology that is to be considered by the semantic parser module to derive training data sets. For example, in order to model a birthplace relation of an individual, in various implementations, a web search for the birthplace of some arbitrary entity may be performed, e.g., query “Elvis birthplace” to retrieve large numbers of training example sentences or utterances relating to the place where Elvis was born. Examples of language snippets returned in response to such a query include, but not limited to, “ . . . the birthplace of Elvis Presley is Tupelo . . . ”, “ . . . Visit Elvis' birthplace in Tupelo . . . ”, “ . . . Elvis was born in Tupelo . . . ”, “ . . . Tupelo is the city where Elvis was born . . . ”, etc. Such snippets provide a large volume of training data instances for the birthplace relation (e.g., {relation: birthplace (entity 1: Elvis, entity 2: Tupelo)}.

The resulting training data is then applied to construct a generic semantic model of the “birthplace” relation for arbitrary entities. Then, if a user utterance contains an assertion such as “ . . . my daughter Jennifer was born in Los Angeles . . . ”, the resulting semantic model will parse that utterance as a first assertion modeled as {birthplace (entity 1: Jennifer, entity 2: Los Angeles)} and a second assertion modeled as {relation: children, relation daughter (entity 1: user, entity 2: Jennifer)}. Similar searches and relation modeling are performed for all triples in the semantic ontology to model each assertion as a relation with corresponding entity slots.

For example, in order to mine real examples of personal assertions that contain personal factual relations, in various implementations, the Utterance-Based Knowledge Tool applies various generic patterns (where “*” represents a wildcard) to extract a candidate training data set. These generic patterns include, but are not limited to, patterns such as “ . . . I am a * . . . ”, “ . . . I am from * . . . ”, “ . . . I have a * . . . ”, “ . . . I live in * . . . ”, “ . . . I was born * . . . ”, “ . . . I work for * . . . ”, “ . . . my * . . . ”, etc. Then a randomly sampled subset of the pooled candidate utterances are manually annotated with several levels of annotations, including, but not limited to, whether the utterance is a personal assertion, identifying each of the relations invoked in the utterance, and tagging the entities, arguments or facts of the relations invoked in the utterance.

The resulting training data is then applied to train one or more semantic models for use by the Utterance-Based Knowledge Tool. For example, in various implementations, k SVM models are constructed for training, where k is the number of relation classes. The i^{th} SVM is trained with all the examples in the i^{th} class (e.g., a “birthplace” relation class) with positive training examples, and all other examples with negative training examples. All SVM models are then applied on each utterance to determine which relations are invoked by any particular utterance.

In other words, in various implementations, the Utterance-Based Knowledge Tool applies one or more semantic ontologies to train semantic models that are capable of parsing and interpreting natural language utterances. For example, given a semantic ontology or graph that defines personal factual relation triples, in various implementations, the Utterance-Based Knowledge Tool mines natural language snippets with a search engine. The resulting snippets contain pairs of related entities to create the training data. This training data is then used to build a combination of language understanding components that enable the Utterance-Based Knowledge Tool to perform various tasks (discussed in the following paragraphs), including, but not limited to:
1) Personal Assertion Classification: for identifying declarative user utterances that contain personal facts and relations relevant to the user, e.g., “my mother's name is Rosa”;
2) Relation Detection: for classifying the declarative user utterances that contain personal facts into one of the predefined relation classes, e.g., a “parents” relation; and
3) Slot Filling: for labeling the attributes or arguments (e.g., the entities) linked by the relation, e.g., {parents (user, Rosa)}.

2.3.1 Personal Assertion Detection and Classification:

In general, the Utterance-Based Knowledge Tool applies both positive and negative examples to classify user utterances into binary classes according to whether or not each utterance contains a statement of personal facts. For example, a positive class instance (i.e., contains personal facts) of a user utterance may be “ . . . I was born in 1999 . . . ” Conversely, an example of a negative class instance (i.e., does not contain personal facts) of a user utterance may be “ . . . how is the weather today?” In various implementations, the Utterance-Based Knowledge Tool addresses this classification question as a binary classification task, and by applying a machine-learning framework (e.g., Support Vector Machines (SVM)) to perform the classification. In various implementations, the Utterance-Based Knowledge Tool applies a multi-stage SVM-based process wherein a first stage provides coarse-grained information on whether it is likely that further SVM levels could extract fine-grained personal factual relations from the user utterance.

2.3.2 Relation Detection:

In general, relation detection is directed towards determining whether one or more relations defined by the semantic ontology have been invoked by a particular user utterance. For example, Table 1 (discussed below in Section 2.4 of this document) shows example utterances that invoke various relations defined by the semantic ontology. Further, as illustrated by Table 1, individual utterances may invoke multiple relations for one or more different entity pairs. In various implementations, the relation detection question is framed as a multi-class classification task that applies various SVM-based techniques to classify each utterance (or portions of each utterance) into one or more relation classes.

In various implementations, the Utterance-Based Knowledge Tool provides a complete query to back-end personal knowledge graph formulation that enables VPAs or other UIs to respond to user queries with relevant personal information drawn from the personal knowledge graph constructed by the Utterance-Based Knowledge Tool. This formulation is enabled by applying the semantic models of the Utterance-Based Knowledge Tool to parse or detect entities invoked in the user's utterance in combination with the corresponding relations invoked by that utterance.

Depending on whether in-domain annotated data is available or not, the semantic models trained using training data (discussed above) for each relation can be used in various ways. Two such example use cases are summarized below:
1) Case 1 (Supervised Baseline): In the supervised case, in-domain annotated data is used for semantic model training and testing. For example, in various implementations, given in-domain annotated user utterances for both training and testing, a 2-fold cross-validation (handout) approach is applied. For each fold, annotated utterances are randomly assigned to two sets d₀ and d₁, so that both sets are of approximately equal size (this can accomplished using various techniques, such as, for example, shuffling the data array and then splitting it in two). Then the SVM model is trained on d₀ and tested on d₁, following by being trained on d₁ and tested on d₀. This has the advantage that both the training and test sets are large, and each data point is used for both training and validation on each fold.
2) Case 2 (Unsupervised): In cases where there is no in-domain annotated data, the mined data can be used to build relation detection SVM models, as discussed above. For example, to simulate cases without available in-domain annotated data (i.e., annotated user utterances), text snippets crawled from the web are used to build models. Model performance is then gauged by determining how well model output matches annotated utterances.

2.3.3 Slot Filling:

The semantic structure of an application domain is defined in terms of semantic frames. The semantic frame contains several typed components referred to as “slots”. As such, the task of slot filling involves instantiating the semantic frames. Table 1, discussed below in Section 2.4 of this document, illustrates slot filling based on entities parsed from several exemplary user utterances. In this case, the semantic frame is represented as a flat list of attribute-value pairs.

In various implementations, the Utterance-Based Knowledge Tool applies discriminative statistical models, such as, for example, conditional random fields (CRFs) for modeling. In general, slot filling is framed as a sequence classification problem to obtain the most probable slot sequence. While the Utterance-Based Knowledge Tool can apply any desired statistical model for this purpose, it has been observed that CRFs often outperform other classification methods for sequence classification because the training can be done discriminatively over a sequence with sentence level optimization. In various implementations, a baseline discriminative statistical model relies on a word n-gram based linear chain CRF, imposing a first order Markov constraint on the model topology.

2.4 Personal Knowledge Graph Construction:

In general, whenever the Utterance-Based Knowledge Tool receives any user utterance, that utterance is processed using semantic models such as those described above (or any other semantic model) to determine whether the utterance include personal facts, and, if so, to parse the relations and associated entities from that utterance relating to those personal facts. Then, the user-centric personal knowledge graph is populated with the relations and the associated entities or arguments parsed from those user utterances. In various implementations, the personal knowledge graph continues to grow over time as more user utterances are received and parsed to extract additional entities and relations that are then integrated into the expanding personal knowledge graph.

More specifically, the personal knowledge graph is a collection of assertions represented by triples consisting of two entities linked by some relation. For example, the assertion {directed_by (Avatar, James Cameron)} specifies that the movie entity “Avatar” was directed by the person entity “James Cameron”, with “directed by” being the relation between these two entities. The Utterance-Based Knowledge Tool may be implemented using any desired ontology for use in constructing personal knowledge graphs. Further, the use of existing ontologies for this purpose increases the interoperability of the resulting personal knowledge graph with various systems, VPAs, UIs, etc.

For example, as noted above, one example of a commonly used ontology for such triples is provided by the “Thing >Person” ontology of schema.org, which defines personal relation types that link various user- or person-centric entities by some relation. Other examples of triple stores covering various user- or person-centric entities include, but are not limited to, the “/people/person/” ontology of freebase.com. However, as noted above, the Utterance-Based Knowledge Tool can use any desired format, structure, or ontology, for modeling or structuring the assertions added to the personal knowledge graph without departing from the scope of the techniques, process, and features described herein.

Examples of relations defined for the triples of each assertion that are relevant to a particular user include, but are not limited to: Date_of_Birth; Place_of_Birth; Country_of_Nationality; Citizenship; Address; Phone_Number; Gender; Profession; Employer; Religion; Ethnicity; Parents; Children; Siblings; Spouse; Marital_Status; Friends; Hobbies; Skills; Employment_History; Education; Schools_Attended; Dietary_Preference, Allergies; Medical_Conditions, Favorite_Sports_Team; etc.

For example, consider the exemplary utterances that are each identified as including triples that describe assertions defined by relations between two entities (one of which may be the user) shown below in Table 1. An exemplary user-centric personal knowledge graph representing the assertion triples of Table 1 is illustrated by FIG. 2 (discussed in further detail following Table 1).

TABLE 1
Example Utterances and Resulting Semantic Space Triples

| Utterance | Relation | Triple: relation (entity 1, entity 2) |
|---|---|---|
| my mother's name is | parent | parent (user, Rosa) |
| Rosa | | |
| my wife's name is Amy | spouse | spouse (user, Amy) |
| my children, Alex and | children | children (user, Alex) |
| Eileen, attend Camarillo | school | children (user, Eileen) |
| High School | siblings | school (Alex, Camarillo High School) |
| | | school (Eileen, Camarillo High School) |
| | | siblings (Alex, Eileen) |
| | | siblings (Eileen, Alex) |
| I was born on Jun. 17, | date_of_birth | date_of_birth (user, Nov. 17, 1991) |
| 1991 in New York City | birthplace | birthplace (user, New York City) |
| I work for Microsoft as a | profession | profession (user, software engineer) |
| software engineer | employment_history | employment history (user, Microsoft) |

In general, FIG. 2 illustrates an exemplary user-centric personal knowledge graph representing the assertion triples of Table 1. This exemplary personal knowledge graph is provided only for purposes of explanation and discussion to show simple examples of various relations connecting entities to form assertions, and should not be construed as limiting the personal knowledge graph to the format illustrated. As illustrated by FIG. 2, relations between entities are shown along connecting arrows that link (i.e., relate) each entity pair.

For example, following the order of utterances illustrated in Table 1, the exemplary personal knowledge graph is centered on “user” entity 200. A “parent” relation links the “Rosa” entity 205 to the “user” entity 200. Similarly, a “spouse” relation links the “Amy” entity 210 to the “user” entity 200. A first instance of the “children” relation links the “Eileen” entity 215 to the “user” entity 200. In addition, based on the user utterance shown in Table 1 (e.g., “ . . . Alex and Eileen, attend Camarillo High School . . . ”), a “school” relation links the “Eileen” entity 215 to the “Camarillo High School” entity 220. A second instance of the “children” relation links the “Alex” entity 225 to the “user” entity 200. In addition, a “school” relation links the “Alex” entity 225 to the “Camarillo High School” entity 220. Next, the “11-17-1991” entity 230 is linked to the “user” entity 200 via a “date_of_birth” relation. Similarly, the “New York City” entity 235 is linked to the “user” entity 200 via a “birthplace” relation. Next, the “software engineer” entity 240 is linked to the “user” entity 200 via a “profession” relation. Finally, the “Microsoft” entity 245 is linked to the “user” entity 200 via an “employment_history” relation.

In addition, as noted above, relations between any two or more entities may be inferred based on relations between other entities. For example, as illustrated by FIG. 2, the “Amy” entity 210 is linked to the “Eileen” entity 215 (and to the “Alex” entity 225, link not shown) by a “parent” relation inferred from the aforementioned “spouse” and “children” relation links to the “user” entity 200. Similarly, the “Eileen” entity 215 and the “Alex” entity 225 are linked to each other by an inferred “siblings” relation because they both have a “children” relation linking them to the “user” entity 200.

Further, as noted above, particular entities may be derived from internet or other searches to provide additional information for existing entities. For example, the “Microsoft” entity 245 is linked to the “One Microsoft Way, Redmond Wash., 98052” entity 250 by an “address” relation derived via an internet or other search of the “Microsoft” entity.

Similarly, in various implementations, the Utterance-Based Knowledge Tool performs queries to obtain additional information for one or more entities either periodically, upon user request, or as soon as those entities have been added to the personal knowledge graph. The personal knowledge graph is then updated with any additional information obtained for those entities. For example, returning to the example of the assertion {school (Alex, Camarillo High School)}, the personal knowledge graph of FIG. 2 can be automatically updated (not shown in FIG. 2) to include information relating to Camarillo High School, such as, for example, teacher names, class schedules, principal name, contact information, etc. Then, depending on the query (e.g., “ . . . I want to talk to my daughter's principal . . . ”), the Utterance-Based Knowledge Tool (or a VPA or other UI) can respond to user queries directly from the personal knowledge graph (e.g., initiate a phone call or email to the principal) without performing additional searches after the user query is issued.

2.4.1 Personal Knowledge Graph Updates and Clarifications:

In general, the personal knowledge graph of a user is expected to evolve over time as new assertions are parsed from declarative user utterances, as existing assertions change or become obsolete over time, and as new inferences between the entities or relations of any new, existing, or updated assertions are made.

For example, new assertions parsed from declarative user utterances are typically simply added to the evolving personal knowledge graph as described throughout this document. However, in various implementations, if new assertions parsed from a new declarative user utterance contradict prior assertions previously added to the personal knowledge graph, the Utterance-Based Knowledge Tool may interact with the user to prompt the user for clarification as to which assertion is correct. Such clarification type prompts may be presented to the user by the Utterance-Based Knowledge Tool as spoken or textual dialog via a VPA or other UI, or via a UI control-based selection, e.g., check-box, radio button or dropdown to confirm assertion changes or updates.

For example, if the personal knowledge graphs includes an “employment” type assertion indicating that the user is a software engineer (e.g., {employment (user, software engineer)}, but a current utterance is parsed to generate an assertion indicating that the user is employed as a farmer, the VPA can query or prompt the user in an attempt to clarify or resolve the ambiguity or contradiction, e.g., “ . . . hey, I thought that you were a software engineer . . . ” or “ . . . did you get a new job as a farmer?” In the case that the user affirms his new job as a farmer, the existing assertion of {employment (user, software engineer)} may be deleted, or updated as {employment_history (user, software engineer)}, while a new assertion such as {employment (user, farmer)} may be added to the personal knowledge graph. Similarly, the Utterance-Based Knowledge Tool may request clarification or authorization to override or replace existing assertions in the personal knowledge graph. For example, school changes for the user's children detected via a declarative user utterance that mentions a new school name relative to the children can be resolved via further dialog with the user).

Alternately, in various implementations, rather than query the user to resolve contradictions, the Utterance-Based Knowledge Tool may simply overwrite any old assertions with new assertions without querying the user. Alternately, in various implementations, the Utterance-Based Knowledge Tool may simply add the new assertion as an alternative or addition to the old assertion.

For example, consider that a prior declarative user utterance of “ . . . my son is Alex . . . ” results in an assertion triple of {children (user, Alex)} that is added to the personal knowledge graph. If a new utterance of the user asserts “ . . . I have a son named Andrew . . . ”, this assertion may result in a clarification type prompt from a VPA or other UI associated with the Utterance-Based Knowledge Tool regarding whether the user's son is named Alex or Andrew. The user response (assuming that response is a relevant declarative utterance) is then parsed to derive a new assertion that is applied to update or correct the personal knowledge graph. Alternately, the resulting assertion may simply replace {children (user, Alex)} with {children (user, Andrew)} to update the personal knowledge graph. Alternately, {children (user, Andrew)} may be added to the personal knowledge graph in combination with a new inferred assertion of {siblings (Alex, Andrew)}.

In the case that an ambiguity exists in either the relation or entity of an assertion for some reason, the Utterance-Based Knowledge Tool may initiate dialog in an attempt to resolve the ambiguity. For example, a declarative user utterance such as “ . . . my son Alex attends Stratford School . . . ” may result in an assertion such as {school (Alex, Stratford School)}. However, if there are two different “Stratford Schools” near the user, e.g., determined via an automated internet search or search of some other data source, then there may be an ambiguity in the “Stratford School” entity of that assertion. Such ambiguities can result in errors in responding to the user (e.g., “ . . . I need directions to my daughter's school . . . ” As another example, assume that the user has a brother named Alex and a son named Alex (e.g., the personal knowledge graph includes assertions such as {children (user, Alex)} and {sibling (user, Alex)}. A declarative user utterance relating to Alex, e.g., “ . . . Alex's birthday is on September 18th . . . ”, is ambiguous as to which Alex is being referenced by that declaration. Clarifications of such ambiguities may be resolved via further dialog with the user (e.g., clarification type prompts such as those mentioned above) with respect to the ambiguous relation or entity.

2.5 Inferring Information for Personal Knowledge Graphs:

In various implementations, the Utterance-Based Knowledge Tool makes a variety of inferences relating to assertions in the personal knowledge graph, or relating to one or more of the entities or relations of one or more of those assertions. For example, such inferences may relate to new inferred relationships between various entities, e.g., the Utterance-Based Knowledge Tool can infer that multiple children entities of the same user entity share a sibling relation. For example, consider the user utterance of “ . . . I have a daughter and she has a brother . . . ” This declarative utterance may result in at least two assertions including {children (user, daughter)} and {siblings (daughter, brother)}. The Utterance-Based Knowledge Tool may then infer an additional assertion of {children (user, son)} from these two assertions because the brother of the user's daughter is likely the user's son.

However, the Utterance-Based Knowledge Tool is not limited to inferences as to familial relations. More specifically, in various implementations, the Utterance-Based Knowledge Tool applies various statistical, machine-learning or deep-learning based techniques to the assertions of the user's personal knowledge graph to infer possible connections between any combination of assertions, entities or relations. New assertions or relation links between entities or assertions are then created to include such inferences in the personal knowledge graph.

Similarly, other characteristics or information relating to one or more of the entities of any assertion can be to make additional inferences. New assertions or relation links between entities or assertions are then created to include such inferences in the personal knowledge graph. For example, in various implementations, the Utterance-Based Knowledge Tool makes various inferences based on user locations (determined using GPS or other localization techniques). For example, if user is in the same GPS location each night, it may be inferred that location corresponds to the user's home address without the user explicitly asserting that information. The inferred address can then be added to the user's personal knowledge graph (e.g., {relation: home_address (entity 1: user, entity 2: 567 First Avenue)}. However, the Utterance-Based Knowledge Tool is not limited to inferences as to user location observations.

Similar location based assertions may be made relating to user work place. For example, where the user arrives at the same location (e.g., One Microsoft Way, Redmond, Wash.) each Monday through Friday between 8:30 and 9:00 AM, and then leaves that location each day at approximately 5:00 PM, the Utterance-Based Knowledge Tool can infer an assertion such as {employment_history (user, Microsoft)} by performing a search on the address. Similarly, assertions may be inferred as to the user's working hours based on those times and locations. Similarly, assertions may be inferred as to favorite restaurants, museums, retail establishments, etc. (e.g., user goes to location of same restaurant or grocery store multiple times over some period).

In various implementations, the Utterance-Based Knowledge Tool provides a VPA- or UI-based mechanism to confirm inferred assertions or relation links between entities. As such, confirmation or rejection of such inferences may be provided by the user via various interactions, including, but not limited to, verbal inputs, gesture-based inputs, textual inputs, checkbox or other UI control based confirmations or rejections, etc. For example, the Utterance-Based Knowledge Tool may infer that the user likes Indian food based on location information showing the user has gone to a particular Indian restaurant multiple times (or multiple different Indian restaurants). An inferred assertion such as, for example, {dietary_preference (user, Indian)} may then be added to user's personal knowledge graph, either with or without user confirmation of the inferred assertion.

2.6 Sharing Personal Knowledge Graphs with Other Users:

In various implementations, the Utterance-Based Knowledge Tool provides various permission-based mechanisms that enables the personal knowledge graph of the user to be partially or fully shared, combined or merged with one or more additional authorized users. For example, assuming that the user grants permission, the personal knowledge graph of that user may be used to populate portions of the personal knowledge graph (e.g., the names, birthdates, genders, and schools of their children, home address, etc.) of user's wife (or other authorized person or virtual entity). Similarly, if multiple members of a family (e.g., mother, father, son, daughter, etc.) are authorized users of a central home computer (with access to each other's files and information, then the Utterance-Based Knowledge Tool may automatically combine the personal knowledge graph of each of those users or otherwise augment the personal knowledge graph of the individual users with entities and relations derived from the personal knowledge graph of one or more of the other family members. Again, in various implementations, such merging or sharing of personal knowledge graphs may be implemented in response to express user permission or authorization.

One advantage of sharing personal knowledge graphs between users is that it provides a broader range of relevant information useable by the Utterance-Based Knowledge Tool to respond to user queries. Another advantage is that this additional information enables the Utterance-Based Knowledge Tool to make additional inferences (See Section 2.5, above) relating to assertions in the expanded or combined personal knowledge graphs, or relating to one or more of the entities or relations of one or more of those assertions.

2.7 Exemplary Usage Scenarios:

In view of the preceding discussion, the personal knowledge graph constructed by the Utterance-Based Knowledge Tool enables a wide range of applications, VPA-based interaction scenarios, UIs, etc. Various examples of some of these uses of the personal knowledge graph are briefly summarized in the following paragraphs. These summarized examples are not intended to be a complete list of uses or interactions with the personal knowledge graphs, and are intended to be understood in view of the preceding detailed description and associated figures relating to the Utterance-Based Knowledge Tool.

Information in the personal knowledge graph enables VPAs or other UIs to respond to seemingly incomplete questions such as, for example, a user query “ . . . what's the score . . . ”. For example, in cases where the personal knowledge graph includes indication of user support for a particular sports team (e.g., {favorite_sports_team (user, Golden State Warriors)}), this information can then be applied by the Utterance-Based Knowledge Tool (or other VPA or UI) to respond to the user query by providing a current score of a basketball game between the Golden State Warriors and whatever team they are currently playing. Such scores can be easily retrieved via a simple automated search of the internet or other database (e.g., automated search for “current score Golden State Warriors”).

In various implementations, the Utterance-Based Knowledge Tool provides various mechanisms to enable the user to manually enter one or more assertions via text, speech, or UI-based selections for use in updating or augmenting the user's personal knowledge graph. For example, the user may be presented with a UI-based list of interests (positive or negative) in particular topics or entities. User selections to indicate likes or dislikes of those entities may then be applied update the personal knowledge graph.

Assertions are not limited to other people or physical entities. For example, in various implementations, the range of assertions covers a wide range of topics and interests, including both subjective and objective assertions, e.g., {relation: political party (entity 1: user, entity 2: democrat)}. Further, in various implementations, the Utterance-Based Knowledge Tool provides a UI or other input mechanism that enables the user to define custom assertions (e.g., new schema entries).

User utterances as to a current state of the user may be relevant to interaction with the user, but not necessarily to the personal knowledge graph. For example, the user may declare or state “ . . . I am driving . . . ” This declarative utterance may be may not result in an assertion to be added to the personal knowledge graphs. However, in various implementations, this user declaration may be parsed by the Utterance-Based Knowledge Tool to set various interaction parameters for a VPA or other interaction source. For example, it may not be safe for the user to engage in various activities while driving. As such, in various implementations, the Utterance-Based Knowledge Tool applies these types of user declarations to set or specify particular allowable interaction parameters while the user is driving. Therefore, in various implementations, the Utterance-Based Knowledge Tool modifies the VPA, UI, or response to the user without necessarily adding or updating entries in the personal knowledge graph. For example, a user declaration such as “ . . . I'll be 5 minutes late to my next meeting . . . ” can be parsed and passed to a calendar domain to reschedule the meeting, or to alert others that the user will be late without necessarily adding or updating entries in the personal knowledge graph.

In various implementations, there is a personal calendar component of the personal knowledge graph that includes a personal calendar of the user and, optionally, calendar entries of one or more other individuals that are identified as being relevant to the user. The Utterance-Based Knowledge Tool can then automatically push calendar updates based on user declarations, user assertions derived from declarations, inferred assertions based on current user location (e.g., user GPS shows he is 10 miles away from a meeting location and moving at 20 miles per hour, presumably in traffic), etc.

In various implementations, assertions are expanded to populate particular fields with relevant information that can be derived from a particular assertion. For example, user may declare “ . . . I'm 21 years old . . . ” The Utterance-Based Knowledge Tool can then compare this assertion of age, e.g., {age (user, 21)} to the current year to derive another assertion such as {birth_year (user, 1994)}.

In various implementations, the Utterance-Based Knowledge Tool extracts one or more assertions relating to a user from one or more publically accessible sources (e.g., LinkedIn, Facebook, online user CV, public document relating to the user, news article relating to the user, etc.). Further, in various implementations, assertions by the user about another person may be used to enhance or update the personal knowledge graph of that other person. For example, a user assertion of “ . . . my nephew Spencer attends Cornell University . . . ” can be used to update a corresponding school relation for Spencer's personal knowledge graph. These types of updates or interactions with the personal knowledge graphs of other users may be permission based, requiring permission or authorization or one or all users. In other words, the Utterance-Based Knowledge Tool can extract assertions and facts from wherever they can be found to add or update the user's personal knowledge graph.

3.0 Operational Summary of the Utterance-Based Knowledge Tool:

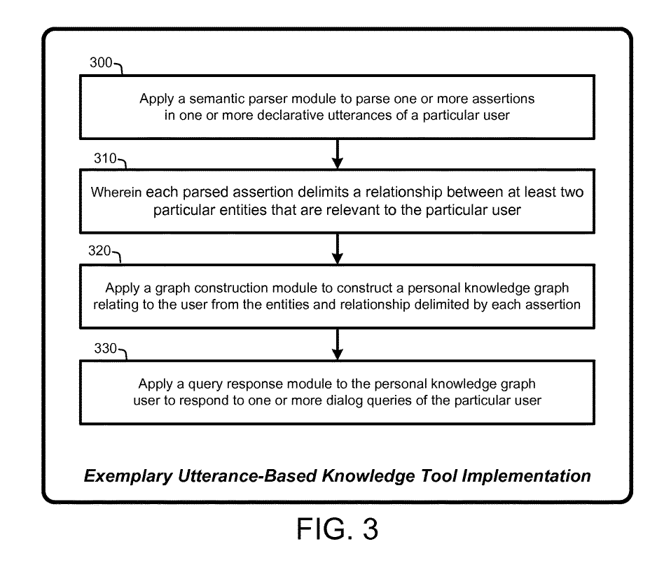

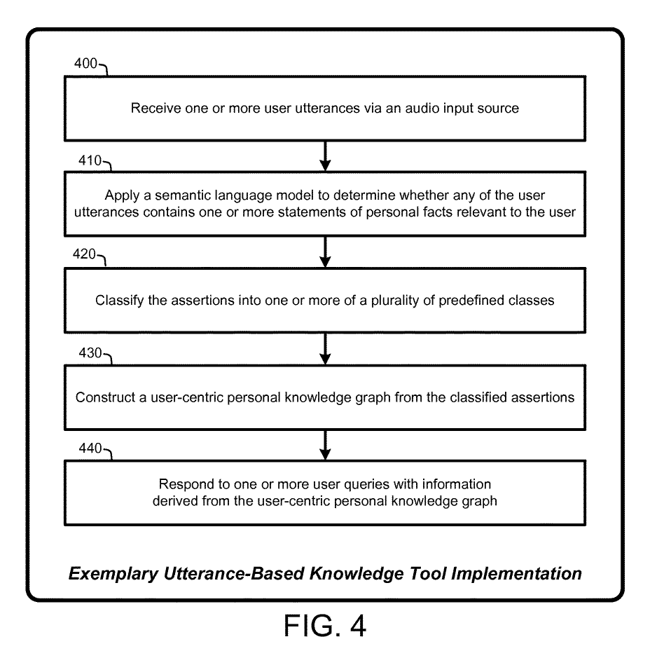

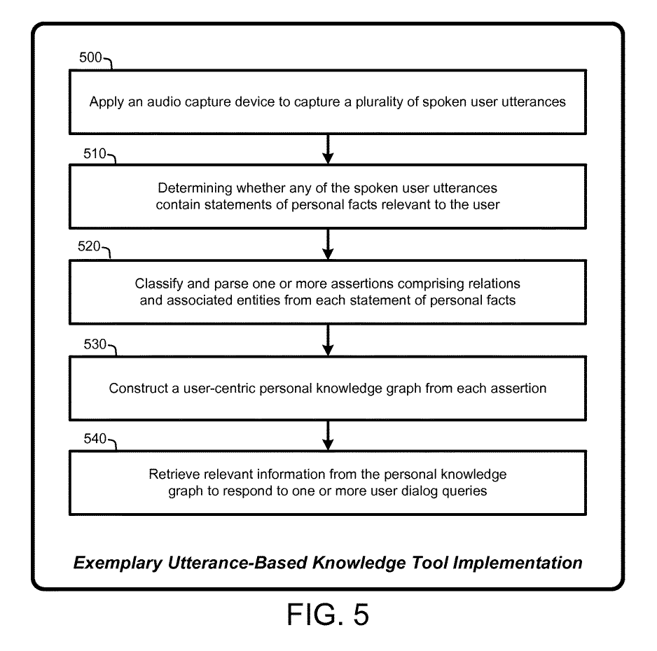

The processes described above with respect to FIG. 1 and FIG. 2, and in further view of the detailed description provided above in Sections 1 and 2, are illustrated by the general operational flow diagrams of FIG. 3, FIG. 4 and FIG. 5. In particular, FIG. 3, FIG. 4 and FIG. 5 provide exemplary operational flow diagrams that summarize the operation of some of the various implementations of the Utterance-Based Knowledge Tool. FIG. 3, FIG. 4 and FIG. 5 are not intended to provide exhaustive representations of all of the various implementations of the Utterance-Based Knowledge Tool described herein, and the implementations represented in FIG. 3, FIG. 4 and FIG. 5 are provided only for purposes of explanation.

Further, any boxes and interconnections between boxes that may be represented by broken or dashed lines in any of FIG. 3, FIG. 4 and FIG. 5 represent optional or alternate implementations of the Utterance-Based Knowledge Tool described herein, and any or all of these optional or alternate implementations, as described below, may be used in combination with other alternate implementations that are described throughout this document.

In general, as illustrated by FIG. 3, in various implementations, the Utterance-Based Knowledge Tool begins operation by applying (300) a semantic parser module to parse one or more assertions in one or more declarative utterances of a particular user. Each parsed assertion delimits (310) a relationship between at least two particular entities that are relevant to the particular user. In addition, a graph construction module is applied (320) to construct a personal knowledge graph relating to the user from the entities and relationship delimited by each assertion. Finally, a query response module is applied (330) to the personal knowledge graph user to respond to one or more dialog queries of the particular user.

In general, as illustrated by FIG. 4, in various implementations, the Utterance-Based Knowledge Tool begins operation by receiving (400) one or more user utterances via an audio input source. In various implementations, the Utterance-Based Knowledge Tool then applies (410) a semantic language model to determine whether any of the user utterances contains one or more statements of personal facts relevant to the user. In various implementations, the Utterance-Based Knowledge Tool then classifies (420) the assertions into one or more of a plurality of predefined classes. In various implementations, the Utterance-Based Knowledge Tool then constructs (430) a user-centric personal knowledge graph from the classified assertions. Finally, in various implementations, the Utterance-Based Knowledge Tool responds (440) to one or more user queries with information derived from the user-centric personal knowledge graph.

In general, as illustrated by FIG. 5, in various implementations, the Utterance-Based Knowledge Tool begins operation by applying (500) an audio capture device to capture a plurality of spoken user utterances. In various implementations, the Utterance-Based Knowledge Tool then determines (510) whether any of the spoken user utterances contain statements of personal facts relevant to the user. In various implementations, the Utterance-Based Knowledge Tool then classifies (520) and parses one or more assertions comprising relations and associated entities from each statement of personal facts. In various implementations, the Utterance-Based Knowledge Tool then constructs (530) a user-centric personal knowledge graph from each assertion. Finally, in various implementations, the Utterance-Based Knowledge Tool then retrieves (540) relevant information from the personal knowledge graph to respond to one or more user dialog queries.

4.0 Exemplary Utterance-Based Knowledge Tool Implementations:

The following paragraphs summarize various examples of implementations that may be claimed in the present document. The implementations summarized below are not intended to limit the subject matter that may be claimed in view of the detailed description of the Utterance-Based Knowledge Tool. Further, any or all of the implementations summarized below may be claimed in any desired combination with some or all of the implementations described throughout the detailed description and any implementations illustrated in one or more of the figures, and any other implementations and examples described below. The following implementations and examples are intended to be understood in view of the detailed description and figures described throughout this document.

In various implementations, the Utterance-Based Knowledge Tool is implemented by means, processes or techniques for automatically populating personal knowledge graphs on a per-user basis based on relations between entities derived from user assertions in user utterances, thereby improving personal relevancy of query responses provided to the user and enhancing the performance of a variety of SLU systems, VPAs and UIs.

As a first example, in various implementations, a system is implemented via means, processes or techniques for directing a general purpose computing device to execute program modules to apply a semantic parser module to parse one or more assertions in one or more declarative utterances of a particular user. Each of these parsed assertion delimits a relationship between at least two particular entities that are relevant to the particular user. In addition, this exemplary system applies a graph construction module to construct a personal knowledge graph relating to the particular user from the entities and relationship delimited by each assertion. In various implementations, this system then applies a query response module to the personal knowledge graph to respond to one or more dialog queries of the particular user.

As a second example, in various implementations, the first example is further modified via means, processes or techniques for applying a machine-learned semantic language module to parse the one or more assertions.

As a third example, in various implementations, any of the first example and the second example are further modified via means, processes or techniques for applying an information request module to prompt the user for additional declarative utterances relating to any entities and relationships that are available in the personal knowledge graph.

As a fourth example, in various implementations, any of the first example, the second example, and the third example are further modified via means, processes or techniques for applying an email and message scraping module to access and extract textual utterances from user email or message content.

As a fifth example, in various implementations, any of the first example, the second example, the third example, and the fourth example are further modified via means, processes or techniques for merging content of the personal knowledge graph of the user with content of one or more personal knowledge graphs of one or more additional users.

As a sixth example, in various implementations, any of the first example, the second example, the third example, the fourth example, and the fifth example are further modified via means, processes or techniques for performing an automated internet search to obtain information relating to an assertion in the personal knowledge graph for responding to one or more dialog queries of the particular user.

As a seventh example, in various implementations, any of the first example, the second example, the third example, the fourth example, the fifth example, and the sixth example are further modified via means, processes or techniques for automatically adding one or more assertions to the personal knowledge graph using additional relationships and entities retrieved via an automated internet search directed to one or more of the assertions in the personal knowledge graph.

As an eighth example, in various implementations, any of the first example, the second example, the third example, the fourth example, the fifth example, the sixth example, and the seventh example are further modified via means, processes or techniques for applying a user interface for manual user entry of assertions for inclusion in the personal knowledge graph.

As a ninth example, in various implementations, any of the first example, the second example, the third example, the fourth example, the fifth example, the sixth example, the seventh example, and the eighth example are further modified via means, processes or techniques for automatically inferring relationship links between one or more of the entities of separate assertions in the personal knowledge graph.

As a tenth example, in various implementations, any of the first example, the second example, the third example, the fourth example, the fifth example, the sixth example, the seventh example, the eighth example, and the ninth example are further modified via means, processes or techniques for automatically inferring one or more assertions for inclusion in the personal knowledge graph based on automated observations of user location.

As an eleventh example, in various implementations, a computer-implemented process is implemented via means, processes or techniques for receiving one or more user utterances via an audio input source. In various implementations, a semantic language model is then applied to determine whether any of the user utterances contains one or more statements of personal facts relevant to the user. In various implementations, one or more assertions are then parsed in each statement of personal facts, each assertion comprising a relation between two entities that are relevant to the user. In various implementations, the assertions are then classified into one or more of a plurality of predefined classes. In various implementations, a user-centric personal knowledge graph is then constructed from the classified assertions. In various implementations, the computer-implemented process then responds to one or more user queries with information derived from the user-centric personal knowledge graph.

As a twelfth example, in various implementations, the eleventh example is further modified via means, processes or techniques for automatically prompting the user for additional statements of personal facts relating to any entities and relations of any assertions in the user-centric personal knowledge graph.

As a thirteenth example, in various implementations, any of the eleventh example and the twelfth example are further modified via means, processes or techniques for performing an automated internet search to obtain information relating to an assertion in the user-centric personal knowledge graph for responding to one or more user queries.

As a fourteenth example, in various implementations, any of the eleventh example, the twelfth example, and the thirteenth example are further modified via means, processes or techniques for automatically adding one or more assertions to the user-centric personal knowledge graph based on additional relations and entities retrieved via an automated internet search directed to one or more of the relations and entities of any of the assertions in the user-centric personal knowledge graph.

As a fifteenth example, in various implementations, any of the eleventh example, the twelfth example, the thirteenth example, and the fourteenth example are further modified via means, processes or techniques for automatically inferring relation links between one or more of the entities of separate assertions in the user-centric personal knowledge graph.

As a sixteenth example, in various implementations, any of the eleventh example, the twelfth example, the thirteenth example, the fourteenth example, and the fifteenth example are further modified via means, processes or techniques for automatically inferring one or more assertions for inclusion in the user-centric personal knowledge graph based on one or more automated observations of user location and corresponding location times.

As a seventeenth example, in various implementations, a computer-readable storage device having computer executable instructions causing a computing device to execute a method is implemented via means, processes or techniques for applying an audio capture device to capture a plurality of spoken user utterances. In various implementations, this method then determines whether any of the spoken user utterances contain statements of personal facts relevant to the user. In various implementations, this method then classifies and parses one or more assertions comprising relations and associated entities from each statement of personal facts. In various implementations, this method then constructs a user-centric personal knowledge graph of the user from each assertion. Finally, in various implementations, this method then retrieves relevant information from the personal knowledge graph to respond to one or more user dialog queries.

As an eighteenth example, in various implementations, the seventeenth example is further modified via means, processes or techniques for performing an automated internet search to retrieve information relating to one or more assertion in the user-centric personal knowledge graph for responding to one or more user queries.

As a nineteenth example, in various implementations, any of the seventeenth example and the eighteenth example are further modified via means, processes or techniques for automatically adding one or more assertions to the user-centric personal knowledge graph based on additional relations and entities retrieved via an automated internet search directed to one or more of the relations and entities of one or more of the assertions in the user-centric personal knowledge graph.

As a twentieth example, in various implementations, any of the seventeenth example, the eighteenth example, and the nineteenth example are further modified via means, processes or techniques for adding automatically inferred relation links between one or more of the entities of separate assertions in the user-centric personal knowledge graph.

5.0 Exemplary Operating Environments:

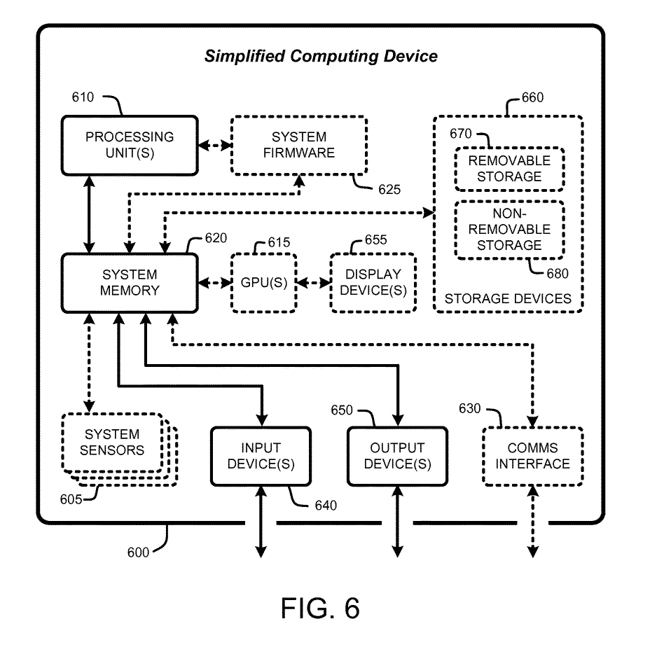

The Utterance-Based Knowledge Tool implementations described herein are operational within numerous types of general purpose or special purpose computing system environments or configurations. FIG. 6 illustrates a simplified example of a general-purpose computer system on which various implementations and elements of the Utterance-Based Knowledge Tool, as described herein, may be implemented. Any boxes that are represented by broken or dashed lines in the simplified computing device 600 shown in FIG. 6 represent alternate implementations of the simplified computing device. As described below, any or all of these alternate implementations may be used in combination with other alternate implementations that are described throughout this document.

The simplified computing device 600 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Utterance-Based Knowledge Tool implementations described herein, the device should have a sufficient computational capability and system memory to enable basic computational operations. In particular, the computational capability of the simplified computing device 600 shown in FIG. 6 is generally illustrated by one or more processing unit(s) 610, and may also include one or more graphics processing units (GPUs) 615, either or both in communication with system memory 620. The processing unit(s) 610 of the simplified computing device 600 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 600 may also include other components, such as, for example, a communications interface 630. The simplified computing device 600 may also include one or more conventional computer input devices 640 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 600 and with any other component or feature of the Utterance-Based Knowledge Tool, including input, output, control, feedback, and response to one or more users or other devices or systems associated with the Utterance-Based Knowledge Tool, are enabled by a variety of Natural User Interface (NUI) scenarios. The NUI techniques and scenarios enabled by the Utterance-Based Knowledge Tool include, but are not limited to, interface technologies that allow one or more users user to interact with the Utterance-Based Knowledge Tool in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 640 or system sensors 605. Such NUI implementations are also enabled by the use of various techniques including, but not limited to, information derived from system sensors 605 or other input devices 640 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Utterance-Based Knowledge Tool.

However, it should be understood that the aforementioned exemplary NUI scenarios may be further augmented by combining the use of artificial constraints or additional signals with any combination of NUI inputs. Such artificial constraints or additional signals may be imposed or generated by input devices 640 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Utterance-Based Knowledge Tool.

The simplified computing device 600 may also include other optional components such as one or more conventional computer output devices 650 (e.g., display device(s) 655, audio output devices, video output devices, devices for transmitting wired or wireless data transmissions, and the like). Typical communications interfaces 630, input devices 640, output devices 650, and storage devices 660 for general-purpose computers are well known to those skilled in the art, and will not be described in detail herein.

The simplified computing device 600 shown in FIG. 6 may also include a variety of computer-readable media. Computer-readable media can be any available media that can be accessed by the computing device 600 via storage devices 660, and include both volatile and nonvolatile media that is either removable 670 and/or non-removable 680, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. The terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Utterance-Based Knowledge Tool implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 625, hardware, or any combination thereof to control a computer to implement the disclosed subject matter. The term “article of manufacture” as used herein is intended to encompass a computer program accessible from any computer-readable device, or media.

The Utterance-Based Knowledge Tool implementations described herein may be further described in the general context of computer-executable instructions, such as program modules, being executed by a computing device. Generally, program modules include routines, programs, objects, components, data structures, and the like, that perform particular tasks or implement particular abstract data types. The Utterance-Based Knowledge Tool implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

6.0 Other Implementations:

The foregoing description of the Utterance-Based Knowledge Tool has been presented for the purposes of illustration and description. It is not intended to be exhaustive or to limit the claimed subject matter to the precise form disclosed. Many modifications and variations are possible in light of the above teaching. Further, any or all of the aforementioned alternate implementations may be used in any combination desired to form additional hybrid implementations of the Utterance-Based Knowledge Tool. It is intended that the scope of the Utterance-Based Knowledge Tool be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Utterance-Based Knowledge Tool described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A system, comprising:
a general purpose computing device; and
a computer program comprising program modules executable by the computing device, wherein the computing device is directed by the program modules of the computer program to:
apply a semantic parser module to parse one or more assertions in one or more declarative utterances of a particular user;
each parsed assertion delimiting a relationship between at least two particular entities that are relevant to the particular user;
apply a graph construction module to construct a personal knowledge graph relating to the particular user from the entities and relationship delimited by each assertion; and
apply a query response module to the personal knowledge graph to respond to one or more dialog queries of the particular user.

2. The system of claim 1 further comprising applying a machine-learned semantic language module to parse the one or more assertions.

3. The system of claim 1 further comprising applying an information request module to prompt the user for additional declarative utterances relating to any entities and relationships that are available in the personal knowledge graph.

4. The system of claim 1 further comprising an email and message scraping module to access and extract textual utterances from user email or message content.

5. The system of claim 1 furthering comprising merging content of the personal knowledge graph of the user with content of one or more personal knowledge graphs of one or more additional users.

6. The system of claim 1 furthering comprising performing an automated internet search to obtain information relating to an assertion in the personal knowledge graph for responding to one or more dialog queries of the particular user.

7. The system of claim 1 furthering comprising automatically adding one or more assertions to the personal knowledge graph using additional relationships and entities retrieved via an automated internet search directed to one or more of the assertions in the personal knowledge graph.

8. The system of claim 1 furthering comprising a user interface for manual user entry of assertions for inclusion in the personal knowledge graph.

9. The system of claim 1 furthering comprising automatically inferring relationship links between one or more of the entities of separate assertions in the personal knowledge graph.

10. The system of claim 1 furthering comprising automatically inferring one or more assertions for inclusion in the personal knowledge graph based on automated observations of user location.

11. A computer-implemented process, comprising:
receiving one or more user utterances via an audio input source;
applying a semantic language model to determine whether any of the user utterances contains one or more statements of personal facts relevant to the user;
parsing one or more assertions in each statement of personal facts, each assertion comprising a relation between two entities that are relevant to the user;
classifying the assertions into one or more of a plurality of predefined classes;
constructing a user-centric personal knowledge graph from the classified assertions; and
responding to one or more user queries with information derived from the user-centric personal knowledge graph.

12. The computer-implemented process of claim 11 further comprising prompting the user for additional statements of personal facts relating to any entities and relations of any assertions in the user-centric personal knowledge graph.

13. The computer-implemented process of claim 11 furthering comprising performing an automated internet search to obtain information relating to an assertion in the user-centric personal knowledge graph for responding to one or more user queries.

14. The computer-implemented process of claim 11 furthering comprising automatically adding one or more assertions to the user-centric personal knowledge graph based on additional relations and entities retrieved via an automated internet search directed to one or more of the relations and entities of any of the assertions in the user-centric personal knowledge graph.

15. The computer-implemented process of claim 11 furthering comprising automatically inferring relation links between one or more of the entities of separate assertions in the user-centric personal knowledge graph.

16. The computer-implemented process of claim 11 furthering comprising automatically inferring one or more assertions for inclusion in the user-centric personal knowledge graph based on one or more automated observations of user location and corresponding location times.

17. A computer-readable storage device having computer executable instructions stored therein, said instructions causing a computing device to execute a method comprising:
applying an audio capture device to capture a plurality of spoken user utterances;
determining whether any of the spoken user utterances contain statements of personal facts relevant to the user;
classifying and parsing one or more assertions comprising relations and associated entities from each statement of personal facts;
constructing a user-centric personal knowledge graph of the user from each assertion; and
retrieving relevant information from the personal knowledge graph to respond to one or more user dialog queries.

18. The computer-readable storage device of claim 17 further comprising instructions for performing an automated internet search to retrieve information relating to one or more assertion in the user-centric personal knowledge graph for responding to one or more user queries.

19. The computer-readable storage device of claim 17 further comprising instructions for automatically adding one or more assertions to the user-centric personal knowledge graph based on additional relations and entities retrieved via an automated internet search directed to one or more of the relations and entities of one or more of the assertions in the user-centric personal knowledge graph.

20. The computer-readable storage device of claim 17 further comprising instructions for adding automatically inferred relation links between one or more of the entities of separate assertions in the user-centric personal knowledge graph.
